(19) United States
(12) Patent Application Publication
(10) Pub. No.: US 2026/0281309 A1
(43) Pub. Date: Sep. 17, 2026

(54) Methods and Apparatus of Simplified Template Cost Computation for Cross-component Prediction Merge Mode

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/472,651

(22) PCT Filed: Jun. 28, 2024
(86) PCT No.: PCT/CN2024/102226

§ 371 Date: Oct. 4, 2025

Related U.S. Application Data
(60) Provisional application No. 63/511,918, filed on Jul. 5, 2023.

(51) Int. Cl. H04N 19/105; H04N 19/132; H04N 19/172; H04N 19/176; H04N 19/186; H04N 19/50

(52) U.S. Cl. CPC H04N 19/105; H04N 19/132; H04N 19/172; H04N 19/176; H04N 19/186; H04N 19/50

(57) ABSTRACT

A method and apparatus using simplified template cost computation are disclosed. According to this method, a set of CCP (Cross-Component Prediction) candidates for the current block is determined. Model errors associated with the set of CCP candidates are determined based on reconstructed samples and predicted samples of one or more templates of the current block, wherein the predicted samples of one or more templates of the current block for each candidate in the set of CCP candidates are generated using a partial model, partial model parameters, precision-reduced model parameters, or a combination thereof. Member candidates in the set of CCP candidates are reordered according to the model errors to form a set of reordered CCP candidates. A target candidate is selected from the set of reordered CCP candidates. The second-colour block is encoded or decoded by using prediction data comprising cross-colour prediction generated using the target candidate.

### CROSS REFERENCE TO RELATED APPLICATIONS

The present invention is a non-Provisional Application of and claims priority to U.S. Provisional Patent Application No. 63/511,918, filed on Jul. 5, 2023. The U.S. Provisional Patent Application is hereby incorporated by reference in its entirety.

### FIELD OF THE INVENTION

The present invention relates to video coding. In particular, the present invention relates to simplified template cost computation for cross-component prediction merge mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

### I. Related Art

### I.1 Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}(i, j) represents the downsampled reconstructed luma samples of the same CU.

In this disclosure, the terms {CCLM_LT, CCLM_L, CCLM_T} and {CCLM_LA, CCLM_L, CCLM_A} and {LM_LA, LM_L, LM_A} are used interchangeably.

The CCLM parameters (α and β) are derived with at most four neighbouring chroma samples and their corresponding down-sampled luma samples. Suppose the current chroma block dimensions are W×H, then W″ and H′ are set as:
W′=W, H′=H when LM_LA mode is applied;
W′=W+H when LM_A mode is applied; and
H′=H+W when LM_L mode is applied.

The above neighbouring positions are denoted as S[0, −1] . . . . S[W′−1, −1] and the left neighbouring positions are denoted as S[−1, 0], . . . , S[−1, H′−1]. Then the four samples are selected as:
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available; and
S[−1, H′/8], S[−1, 3*H′/8], S[−1, 5*H′/8], S[−1, 7*H′/8] when LM_L mode is applied or only the left neighbouring samples are available.

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \\ {Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1 \qquad ( 2 )$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

FIG. 2 shows an example of the location of the left and above samples and the sample of the current block involved in the LM_LA mode.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM_LA mode, left and above templates are used to calculate the linear model coefficients.

### I.2 Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

In this disclosure, the terms MMLM_LT and MMLM_LA are used interchangeably.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>=Threshold is classified into group 2.

$$\{ \begin{matrix}{Pred}_{C} [ x , y ] = {α}_{1} \times {Rec}_{L}^{′} [ x , y ] + {β}_{1} & if {Rec}^{′} [ x , y ] \leq Threshold \\ ( {Pred}_{C} [ x , y ] = {α}_{2} \times {Rec}_{L}^{′} [ x , y ] + {β}_{2} & if {Rec}^{′} [ x , y ] > Threshold\end{matrix} \qquad ( 5 )$$

### I.3 Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south(S), left/west (W) and right/east (E) neighbours as illustrated in FIG. 4.

The nonlinear term (denoted as P) is represented as power of two of the centre luma sample C and scaled to the sample value range of the content:

$$P = ( C * C + midVal ) >> \text{bitDepth.}$$

That is, for 10-bit content it is calculated as:

$$P = ( C * C + 512 ) >> 10.$$

The bias term (denoted as B) represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### I.4 Gradient Linear Model (GLM)

For YUV 4:2:0 colour format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged:

$$C = α \cdot G + β .$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled to the current CU, one flag is signalled to indicate whether GLM is enabled for both Cb and Cr components; if the GLM is enabled, another flag is signalled to indicate which of the two GLM modes is selected and one syntax element is further signalled to select one of 4 gradient filters for the gradient calculation.

Four gradient filters (510-540) are enabled for the GLM, as illustrated in FIG. 5.

For cross-component prediction (CCP) merge mode, the template costs associated with the CCP candidates are calculated for reordering the candidates or selecting a target candidate. The computational complexity for template cost computation may be high. In order to reduce the complexity of template cost computation, methods of simplified template cost for CCP merge mode are disclosed.

### BRIEF SUMMARY OF THE INVENTION

A method and apparatus for coding colour pictures using coding tools including one or more cross component models related modes are disclosed. According to this method, input data associated with a current block comprising a first-colour block and a second-colour block is received, wherein the input data comprise pixel data to be encoded at an encoder side or data associated with the current block to be decoded at a decoder side. A set of CCP (Cross-Component Prediction) candidates for the current block is determined. Model errors associated with the set of CCP candidates are determined based on reconstructed samples and predicted samples of one or more templates of the current block, wherein the predicted samples of one or more templates of the current block for each candidate in the set of CCP candidates are generated using a partial model, partial model parameters, precision-reduced model parameters, or a combination thereof. Member candidates in the set of CCP candidates are reordered according to the model errors to form a set of reordered CCP candidates. A target candidate is selected from the set of reordered CCP candidates. The second-colour block is encoded or decoded by using prediction data comprising cross-colour prediction generated using the target candidate.

In one embodiment, the set of CCP candidates comprise a multi-mode candidate and only a single-mode of the multi-mode candidate is used to generate the predicted samples of one or more templates of the current block. In one embodiment, the multi-mode candidate corresponds to MMLM (Multiple Model CCLM (Cross-Component Linear Model)) or CCCM (Convolutional Cross-Component Mode) multi-model.

In one embodiment, one member candidate in the set of CCP candidates comprises m model parameters and only k model parameters are used to generate the predicted samples of one or more templates of the current block, wherein m and k are positive integers and m>k. In one embodiment, one or more remaining model parameters not selected to generate the predicted samples of one or more templates of the current block are set to 0. In one embodiment, a corresponding model error for the member candidate is modified by adding an offset to form a final model error. In one embodiment, the offset corresponds to a fixed value or a mean of said one or more templates.

In one embodiment, bit-depth reduced model parameters of one member candidate in the set of CCP candidates are used to generate the predicted samples of one or more templates of the current block. In one embodiment, clipping operation is used to generate the bit-depth reduced model parameters of the member candidate in the set of CCP candidates. In one embodiment, pruning operation is used to generate the bit-depth reduced model parameters of the member candidate in the set of CCP candidates. In one embodiment, if one model parameter is smaller than a pruning threshold, said one model parameter is set to zero. In one embodiment, rounding operation is used to generate the bit-depth reduced model parameters of the member candidate in the set of CCP candidates.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of sample locations used for deriving α and β of the cross-component model.

FIG. 3 illustrates an example of classifying the neighbouring samples into two groups for MMLM.

FIG. 4 illustrates the spatial part of the convolutional filter.

FIG. 5 shows 4 gradient patterns for GLM.

FIG. 6 illustrates the 5 neighbouring blocks used for deriving spatial merge candidates for VVC.

FIG. 7 illustrates an example of inheriting temporal neighbouring model parameters.

FIGS. 8A-B illustrates two search patterns for inheriting non-adjacent spatial neighbouring models.

FIG. 9 illustrates an example of the neighbouring templates for calculating model error for reordering the candidates.

FIG. 10 illustrates a flowchart of an exemplary video coding system that uses simplified template cost computation for CCP merge mode according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to simplify template cost computation for CCP merge mode according to an embodiment of the present invention.

### II. Proposed Method

### II.1 Inheriting Neighbouring Model Parameters for Refining the Cross-Component Model Parameters

When applying cross-component prediction coding tool on the current block to generate prediction signals, the cross-component model (CCM) information (more details in section entitled: “Inheriting CCM information”) including model parameters can be inherited from neighbouring blocks.

In one embodiment, if the inherited neighbouring block is coded in CCLM mode, the final scaling parameter of the current block is inherited from the neighbouring blocks. Once the final scaling parameter is determined, the offset parameter (e.g., β in CCLM) is derived based on the inherited scaling parameter and/or the average value of neighbouring luma and chroma samples of the current block.

In one embodiment, if the inherited neighbour block is coded in CCLM mode, after inheriting model parameters, the offset parameter can be inherited or can be further refined by dB. For example, if the final offset parameter is inherited from a selected neighbouring block, and the inherited offset parameter is B′ₙₑᵢ, then the final scaling parameter is (β′ₙₑᵢ+dB). dB can be zero.

In one embodiment, if the inherited neighbour block is coded with CCCM, the filter coefficients (cᵢ) are inherited. The offset parameter (e.g., c₆×B or c, in CCCM) can be re-derived based on the inherited parameter and the average value of neighbouring corresponding position luma and chroma samples of the current block.

In one embodiment, if the inherited neighbour block is coded with CCCM, the filter coefficients (cᵢ) are inherited. The offset parameter (e.g., c₆×B or c₆ in CCCM) is also inherited and is not re-derived.

In one embodiment, if the inherited candidate applies GLM gradient pattern to its luma reconstruction samples, the current block shall also inherit the GLM gradient pattern of the candidate and apply to the current luma reconstruction samples.

In one embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group.

### II.2 Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate that non-downsampled samples are used in convolutional model, down-sampling filter flag, down-sampling filtering index when multiple down-sampling filters are used, number of neighbouring lines used to derive model, types of templates used to derive model, post-filtering flag and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 (Ramin G. Youvalari, et al., “Non-EE2: Gradient and location based convolutional cross-component model (GL-CCCM) for intra prediction”, Joint Video Exploration Team (JVET) of ITU-T SG 16 WP 3 and ISO/IEC JTC 1/SC 29/WG 11, 28th Meeting, Mainz, DE, 20-28 Oct. 2022, Document: JVET-AB0119) is a mixed CCCM model which consists of one spatial term in centre position, two gradient terms for the horizontal direction and the vertical direction, two location terms X and Y for the relative horizontal location and relative vertical location, one non-linear term and one bias term. A prediction mode can be stored in the CCM information to indicate that the inherited model is a GL-CCCM model.

### II.3 Inheriting Spatial Neighbouring Model Parameters

In one embodiment, the inherited model parameters can be from a block that is an immediate neighbouring block. The models from blocks at pre-defined positions are added into the candidate list in a pre-defined order.

In one embodiment, the pre-defined positions and the pre-defined order can be the same as those of spatial candidates for inter merge mode.

In one embodiment, the pre-defined positions can be the positions depicted in FIG. 6. The pre-defined order can be B₀, A₀, B₁, A₁ and B₂.

In one embodiment, assume the position, width and height of the current block are (x, y), W and H respectively, the pre-defined positions can include positions immediate above the current block, such as (x+W>>1, y−1) or (x+(W+1)>>1, y−1), if W is greater than or equal to a threshold TH. The pre-defined positions can also include positions immediate left to the current blocks, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbours that can be added into the candidate list, and the maximum number is smaller than the number of pre-defined positions.

### II.4 Inheriting Temporal Neighbouring Model Parameters

In one embodiment, if the current slice/picture is a non-intra slice/picture, the inherited model parameters can be from the block in the previous coded slices/pictures.

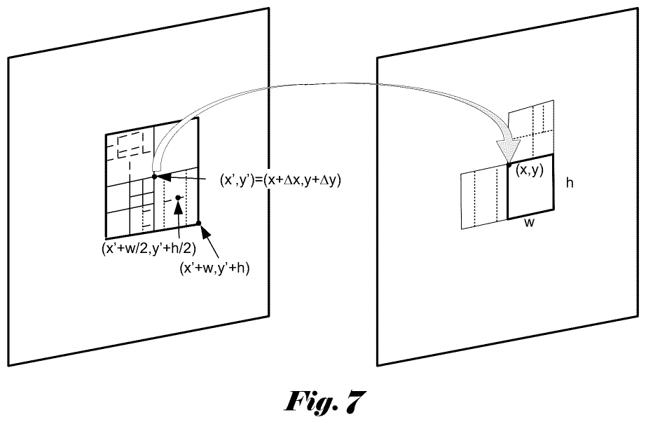

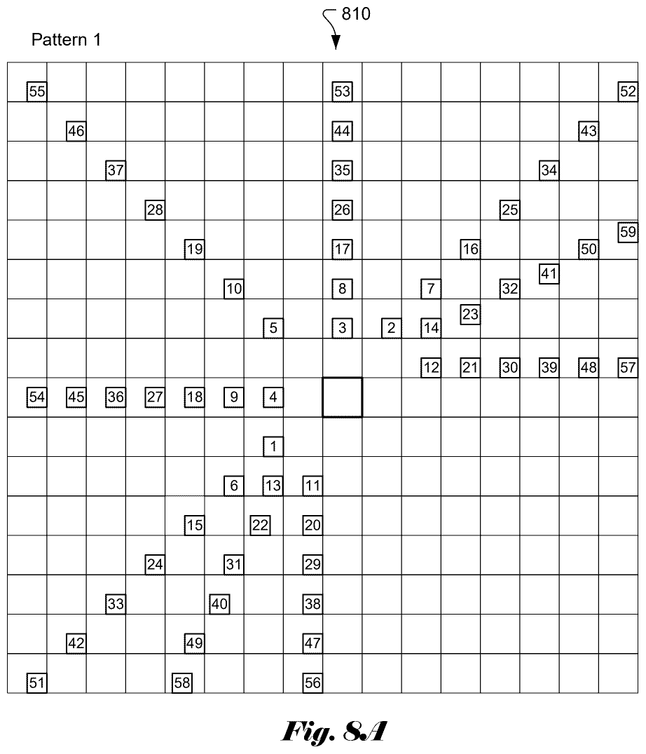

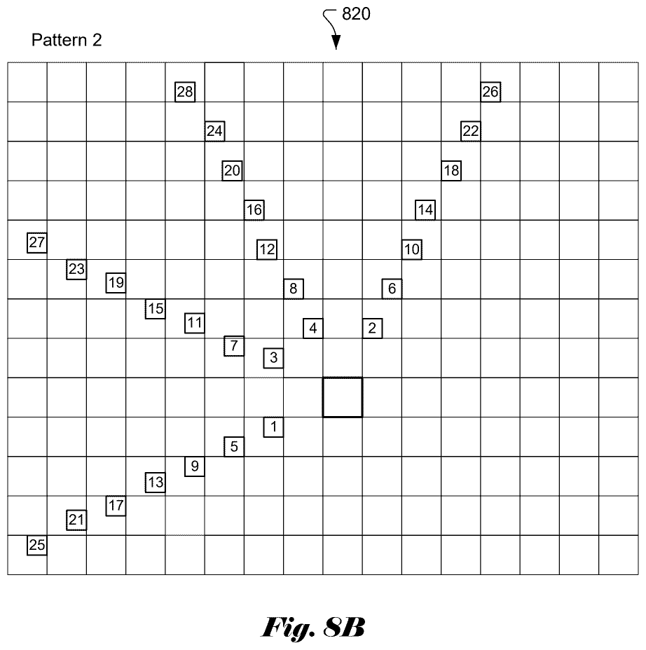

In one embodiment, if the current slice/picture is a non-intra slice/picture, the inherited model parameters can be from the block in the previous coded slices/pictures. For example, as shown in FIG. 7, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In one embodiment, if the prediction mode of the current block is intra, Δx and Δy are set to 0. If the prediction mode of the current block is inter, Δx and Δy are set to the horizontal and vertical motion vectors of the current block. In one embodiment, if the current block is inter bi-prediction, Δx and Δy are set to the horizontal and vertical motion vectors in reference picture list 0. In one embodiment, if the current block is inter bi-prediction, Δx and Δy are set to the horizontal and vertical motion vectors in reference picture list 1.

In one embodiment, if the current slice/picture is a non-intra slice/picture, the inherited model parameters can be from the block in the previous coded slices/pictures. In one embodiment, the current block position is at (x, y) and the block size is w×h. The two value sets ax and ay are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {α}_{yi} < {α}_{yj} if i < j$$

All values in ax and ay are positive numbers. Let (x_{mid}, y_{mid})=(x+w/2, y+h/2).

The inherited model parameters can be from the block at positions (x_{mid}±αₓᵢ×W, y_{mid}+α_{yi}×h), (x_{mid}+αₓᵢ×W, y_{mid}), (x_{mid}, y_{mid}+α_{yi}×h) of the previous coded slices/picture. In one sub-embodiment, αₓ=α_{y}. For example, αₓ=α_{y}={1, 2, 3, 4, 5}.

In another sub-embodiment, αₓ≠α_{y}. For example, α_x={1/2, 1, 3/2, 2, 5/2} and α_{y}={1, 2, 3, 4, 5}.

In another embodiment, the current block position is at (x, y) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), or (x, y−α_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, α_x={1/2, 1, 3/2, 2, 5/2} and α_{y}={1, 2, 3, 4, 5}.

In one embodiment, the models from the positions closer to (x_{mid}, y_{mid}) are added into the final merge candidate list first. In another embodiment, the models from the positions closer to (x, y) are added into the final merge candidate list first.

In one embodiment, let δx and δy be two fixed positive numbers. The inherited model parameters can be from the block at positions (x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, y_{mid}), (x_{mid}−αₓᵢ×δx, y_{mid}), (x_{mid}, y_{mid}+α_{yi}×δy), or (x_{mid}, y_{mid}−α_{yi}×δy) of the previous coded slices/picture.

In another embodiment, the current block position is at (x, y) and the block size is w×h. Let δx and y be two fixed positive numbers The inherited model parameters can be from the block at positions (x+αₓᵢ×δx, y+α_{y}; ×δy), (x+αₓᵢ×δx, y−α_{yi}×δy), (x−αₓᵢ×δx, y+α_{yi}×δy), (x−αₓᵢ×δx, y−α_{yi}×δy), (x+αₓᵢ×δx, y), (x−αₓᵢ×δx, y), (x, y+α_{yi}×δy), or (x, y−α_{yi}× δy) of the previous coded slices/picture.

In another embodiment, the current block position is at (x, y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at (x, y), (x+w−1, y), (x, y+h−1), (x+w−1, y+h−1), or (x+w/2, y+h/2). For another example, the positions are outside of the corresponding area of the current encoding block, i.e., x′<x+ or x′≥x+w, and y′<y or y′≥y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), or (x+w, y+h).

In one embodiment, the inherited model parameters can be from the block at some pre-defined positions. The pre-defined positions and the inclusion order can be the same as those of inter merge mode

The previous coded picture which the inherited parameter model is from is referred as the collocated picture hereafter.

In one embodiment, the previous coded picture where the inherited parameter model is from (i.e., the collocated picture) is one of the pictures in the reference lists.

In one embodiment, the collocated picture can be the same as the collocated picture of inter merge mode.

In one embodiment, the collocated picture is signalled in the picture/slice header. The reference list and the reference index are signalled in the picture/slice header. For example, the collocated picture is selected as L0[0]. For another example, the collocated picture is selected as L1 [0].

In one embodiment, the collocated picture is selected as the picture in the reference lists whose POC difference between the respective picture and the current picture is the smallest. For example, if the POC of current picture is 8, the POCs of pictures in reference list 0 are {7, 6, 5, 0} and POCs of pictures in reference list 1 are {7, 6, 5, 4}, then L0[0] (equivalent to L1 [0]) is selected since its POC difference is the smallest.

In one sub-embodiment, if there are two pictures whose POC difference between the respective picture and the current picture are both the smallest, the picture with the smaller POC is selected.

In one sub-embodiment, if there are two pictures whose POC difference between the respective picture and the current picture are both the smallest, the picture with the larger POC is selected.

In another sub-embodiment, if there are two pictures whose POC difference between the respective picture and the current picture are both the smallest, the picture with smaller QP difference between the respective picture and the current picture is selected.

In another sub-embodiment, if there are two pictures whose POC difference between the respective picture and the current picture are both the smallest, the picture with the smaller QP is selected.

In another sub-embodiment, if there are two pictures whose POC difference between the respective picture and the current picture are both the smallest, the picture with the larger QP is selected.

In one embodiment, the collocated picture is selected as the picture in the reference lists whose QP difference between the respective picture and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected.

In one sub-embodiment, if there are more than one picture in the reference lists whose QP difference between the respective picture and the current picture are the smallest, the picture with the smaller QP is selected.

In another sub-embodiment, if there are more than one picture in the reference lists whose QP difference between the respective picture and the current picture are the smallest, the picture with the larger QP is selected.

In another sub-embodiment, if there are more than one picture whose QP difference between it and the current picture are the smallest, the picture with the smaller POC distance is selected.

In one embodiment, the collocated picture is selected as the picture in the reference lists whose QP is the smallest.

In another embodiment, the collocated picture is selected as the picture in the reference lists whose QP is the largest.

In one embodiment, the previous coded picture which the inherited parameter model is from, i.e., the collocated picture, is the most recently coded I-picture. The cross-component model information of the most recently coded I-slice/picture is stored in a long-term reference buffer.

In one embodiment, the collocated picture and the pre-defined positions where the inherited parameter model is from is determined by the motion vector of a neighbouring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′ +h), or (x′+w, y′+h) of the collocated picture, where x′=x+Δx and y′=y+Δy.

In one sub-embodiment, Δx and Δy are set to the L0 horizontal and vertical motion vectors of the neighbouring block, and the collocated picture is the L0 reference picture indicated by the L0 motion vector of the neighbouring block.

In one sub-embodiment, if the neighbouring block is inter bi-prediction, Δx and Δy are set to the L1 horizontal and vertical motion vectors of the neighbouring block, and the collocated picture is the L1 reference picture indicated by the L1 motion vector of the neighbouring block.

In one sub-embodiment, the neighbouring block is the left block of the current block.

In another sub-embodiment, the neighbouring block is the above block of the current block.

In one embodiment, the pre-defined positions in the previous coded slices/pictures where the inherited parameter model is from is determined by the motion vector of a neighbouring block. Let Δx and Δy be the horizontal and vertical displacements determined based on the selected motion vector of the neighbouring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In another embodiment, the inherited model parameters can also be from the block positions in the patterns described in earlier paragraphs. The positions are centred at (x′, y′), where x′=x+Δx and y′=y+Δy, or where x′=x+w/2+Δx and y′=y+h/2+Δy. That is, denote the pre-defined positions as (x₁, y₁), (x₂, y₂), (x₃, y₃), . . . , (x_{N}, y_{N}), the inherited model parameters can be from (x₁+Δx, y₁+Δy), (x₂+Δx, y₂+Δy), (x₃+Δx, y₃+Δy), . . . , (x_{N}+Δx, y_{N}+Δy), where Δx and Δy are the horizontal and vertical displacements determined based on the selected motion vector of the neighbouring block. For example, let the current block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. The inherited model parameters can be from the block at positions (x′+αₓᵢ×w, y′+α_{yi}×h), (x′+αₓᵢ×w, y′−α_{yi}×h), (x′−αₓᵢ×W, y′+α_{yi}×h), (x′−αₓᵢ×w, y′−α_{yi}×h), (x′+αₓᵢ×w, y′), (x′−αₓᵢ×w, y′), (x′, y′+α_{yi}×h), or (x′, y′−α_{yi}×h) of the previous coded slices/picture. For another example, let &x and δy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, y′), (x′−αₓᵢ×δx, y′), (x′, y′+α_{yi}×δy), or (x′, y′−α_{yi}× δy) of the previous coded slices/picture. For another example, the inherited model parameters can be from the block at some pre-defined positions relative to (x′, y′) of the previous coded slices/picture. The positions can be (x′, y′), (x′+w−1, y′), (x′, y′+h−1), (x′+w−1, y′+h−1), or (x′+w/2, y′+h/2). For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), or (x′+w, y′+h).

In one embodiment, the neighbouring block can be at a pre-defined position. For example, the position can be at the A₀ position as depicted in FIG. 6. The pre-defined position can also be at A₁, B₀, B₁, B₂. If the block at the pre-defined position is not an inter block, no neighbouring block is selected.

In another embodiment, when selecting the neighbouring block, there can be a list of pre-defined positions. The positions are placed according to the checking order. For example, the positions can be B₀, A₀, B₁, A₁ and B₂ as depicted in FIG. 6. The selected neighbouring block can be the first position in the list that is an inter block. The L0 motion vector is selected. If the L0 motion vector is not available, select the L1 motion vector. For another example, the L1 motion vector is selected. If the L1 motion vector is not available, select the L0 motion vector

In another embodiment, if the collocated picture has been determined (e.g., it can be determined with the methods described in earlier paragraphs in this section), the positions in the list of pre-defined positions are checked in the pre-defined checking order. The selected motion vector is the first whose reference picture is the collocated picture. For example, the positions can be B₀, A₀, B₁, A₁ and B₂ as depicted in FIG. 6. For each position, the L0 motion vector is first checked, and then the L1 motion vector. That is, the checking order is (B₀, L₀), (B₀, L₁), (A₀, L₀), (A₀, L₁), . . . , (B₂, L₁). For another example, the L₁ motion vector is first checked, and then the L₀ motion vector.

In one embodiment, the inherited model parameters can also be from the block positions in the patterns described in earlier paragraphs. The positions are centred at (x′, y′), where x′=x+Δx and y′=y+Δy. The horizontal and vertical displacements Δx and Δy are determined based on the selected motion vector of the neighbouring block. For example, if the reference picture of the selected motion vector and the collocated picture are the same picture, Δx equals to the horizontal part of the selected motion vector and Δy equals to the vertical part of the selected motion vector. If the horizontal part or the vertical part of the selected motion vector is fractional, Δx equals to the horizontal part of the selected motion vector after rounding and Δy equals to the vertical part of the selected motion vector after rounding. The rounding method used can be but not limited to the following methods: rounding toward negative infinity, rounding toward positive infinity, rounding toward zero, or rounding to the nearest integer (e.g., rounding away from zero, rounding half up, rounding half down, . . . ). For another example, if the reference picture of the selected motion vector and the collocated picture are not the same. The reference picture can be one of the pictures in the reference list, while the collocated picture is signalled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to mv_x*(td/tb) after rounding or the horizontal part of the selected motion vector after rounding and Δy equals to mv_y*(td/tb) after rounding or the vertical part of the selected motion vector after rounding. The rounding method used can be, but not limited to, the following methods: rounding toward negative infinity, rounding toward positive infinity, rounding toward zero, or rounding to the nearest integer (e.g., rounding away from zero, rounding half up, rounding half down, . . . ).

In one embodiment, the inherited model parameters are derived by using the luma and chroma reconstruction samples of the collocated block. Let the current block position be at (x, y) and the block size is w×h. The collocated block is a block positioned at (x′, y′) in the collocated picture with block size w×h, when the inherited model is from position (x′, y′). For another example, the collocated block can be a block positioned at (x′, y′) in the collocated picture with block size m×n, where m and n are fixed positive values. For example, the collocated block can be at (x, y). For another example, if Δx and Δy are the L₀ horizontal and vertical motion vectors of the neighbouring block, and the collocated picture is the L₀ reference picture indicated by the L₀ motion vector of the neighbouring block, the collocated block can be at (x+Δx, y+Δy) in the collocated picture. (x′, y′) can be the block positions in the patterns described in earlier paragraphs. For example, (x′, y′) can be (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), or (x, y−α_{yi}×h).

In one embodiment, the cross-component parameter model can be inherited from more than one previous coded picture. The cross-component parameter model can be inherited from any picture in a picture set, which contains N previous coded pictures. An index can be signalled/parsed in the bitstream to indicate the selected picture. The index ranges from 0 to N−1. In one sub-embodiment, the picture whose POC difference between itself and the current picture is smaller is associated with the smaller index. In another sub-embodiment, the picture whose QP difference between itself and the current picture is smaller is associated with the smaller index. In another sub-embodiment, the picture whose QP is smaller is associated with the smaller index. In another sub-embodiment, the picture whose QP is larger is associated with the smaller index.

### II.5 Inheriting Non-Adjacent Spatial Neighbouring Models

In one embodiment, the inherited model parameters can be from blocks that are non-adjacent spatial neighbouring blocks. The models from blocks at pre-defined positions are added into the candidate list in a pre-defined order.

In one sub-embodiment, the pre-defined positions and the pre-defined order are the same as those of non-adjacent spatial neighbouring candidates for inter merge mode.

In one sub-embodiment, the pre-defined positions and the pre-defined order are as depicted in FIG. 8A and FIG. 8B. The positions of the numbered squares are the pre-defined positions. The number inside each square indicates the pre-defined order. Positions in Pattern 1 (810) is added into the list before positions in Pattern 2 (820). The distance between each pre-defined positions are proportional to the width and height of the current block.

In one embodiment, there is a maximum number of inherited models from non-adjacent spatial neighbours that can be added into the candidate list, and the maximum number is smaller than the number of pre-defined positions.

In one embodiment, let the current block position be (x, y) and the block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j \\ {α}_{y} = \{ {α}_{y 1} , {α}_{y 2} , {α}_{y 3} , … , {α}_{yn} \} , {α}_{yi} < {α}_{yj} if i < j$$

All values in a and α_{y} are positive numbers. Let x′=x+Δx and y′=y+Δy. The inherited model parameters can be from the positions determined by x′ and y′. For example, the inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w, y′), (x′, y′+α_{yi}×h), (x′, y′−α_{yi}× h), (x′+αₓᵢ×w, 0), (x′−αₓᵢ×w, 0), (0, y′+α_{yi}× h), or (0, y′−α_{yi}×h). For another example, let δx and δy be two fixed positive numbers. The inherited model parameters can be from the block at positions (x′+αₓᵢ×δx, y′+α_{yi}×δy), (x′+αₓᵢ×δx, y′−α_{yi}× δy), (x′−αₓᵢ×δx, y′+α_{yi}× δy), (x′−αₓᵢ×δx, y′−α_{yi}×δy), (x′+αₓᵢ×δx, y′), (x′−αₓᵢ×δx, y′), (x′, y′+α_{yi}×δy), (x′, y′−α_{yi}×δy), (x′+αₓᵢ× δx, 0), (x′−αₓᵢ×δx, 0), (0, y′+α_{yi}×δy), or (0, y′−α_{yi}×δy). For another example, the inherited model parameters can be from the block at some pre-defined positions relative to (x′, y′) of the previous coded slices/picture. The positions can be (x′, y′), (x′+w−1, y′), (x′, y′+h−1), (x′+w−1, y′+h−1), or (x′+w/2, y′+h/2). For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), or (x′+w, y′+h). For another example, the position can be (x′, y′), (x′, y′+h/2), (x′+w/2, y′), (x′+w/2, y′+h/2), (x′+w, y′), (x′, y′+h), or (x′+w, y′+h).

In one sub-embodiment, if the prediction mode of the current block is IBC, Δx and Δy can be set according to the horizontal and vertical block vectors of the current block. For example, Δx and Δy can be equal to the horizontal and vertical block vectors of the current block.

In another sub-embodiment, Δx and Δy can be set according to the horizontal and vertical block vectors of a neighbouring block. For example, Δx and Δy can be equal to the horizontal and vertical block vectors of a neighbouring block.

II.6 Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidates can be from the beginning of the table to the end of the table. In another embodiment, the adding order of historical candidates can be from the end of the table to the beginning of the table.

In one embodiment, one cross-component model history table can be maintained for storing the previous cross-component model (i.e., CCM information), and the cross-component model history table can be reset at the start of the current picture, current slice, current tile, every M CTU rows or every N CTUs, where N and M can be any value greater than 0. In another embodiment, the cross-component model history table can be reset at the end of the current picture, current slice, current tile, current CTU row or current CTU.

In another embodiment, multiple history tables are used for storing different types of cross-component models. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=αₓ+b), and the second history table is used for storing complicated model (e.g., CCCM).

In one embodiment, when adding historical candidates from multiple history tables to the candidate list, the adding order can be from the beginning of to the end of a certain table, and then the next history table is added in the same order or in a reversed order.

II.7 Inheriting from Fusion Mode

Fusion mode refers to a mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### II.8 Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates.

In another embodiment, if all the pre-defined neighbouring and historical candidates are added but the maximum candidate number is not reached, some default candidates are added into the candidate list until the maximum candidate number is reached.

In one embodiment, the default candidates can be CCLM models. The scaling parameter α is from the set {0, ⅛, −⅛, + 2/8, − 2/8, +⅜, −⅜, + 4/8, − 4/8, . . . , +N/8, −N/8}, where N is a positive integer. The offset parameter β can be 1/(1<<bit_depth) or can be derived based on neighbouring luma and chroma samples. For example, if the average value of neighbouring luma and chroma samples are lumaAvg and chroma Avg, β=chroma Avg−α·lumaAvg. In one sub-embodiment, the inclusion order of the default candidates can depend on the absolute value and the sign of the scaling parameter a. For example, the default candidates are added into the list in the following order: α=0, ⅛, −⅛, + 2/8, − 2/8, +⅜, −⅜, + 4/8, − 4/8, . . . , +N/8, −N/8.

In another embodiment, a default candidate can be an earlier candidate with a delta scaling parameter refinement. The earlier candidate is a CCLM model. If the scaling parameter of an earlier candidate is a, the scaling parameter of a default candidate is (α+Δα). For example, Δα can be ⅛, −⅛, + 2/8, − 2/8, +⅜, −⅜, + 4/8, − 4/8, . . . , +N/8, −N/8, where N is a positive integer. The offset parameter β can be derived based on (α+Δα) and the average values of neighbouring luma and chroma samples of the current block. In one sub-embodiment, the earlier candidate is the first CCLM candidate added into the list. In one sub-embodiment, the inclusion order of the default candidates can depend on the absolute value and the sign of the refinement Δα. For example, the default candidates are added into the list in the following order: Δα=0, ⅛, −⅛, + 2/8, − 2/8, +⅜, −⅜, + 4/8, − 4/8, . . . , +N/8, −N/8.

### II.9 Reordering the Candidates in the List

The candidates in the list can be reordered to reduce the syntax overhead when signalling the selected candidate index. The reordering rules can depend on the coding information of neighbouring blocks or the model error. For example, if neighbouring above or left blocks are coded by MMLM, the MMLM candidates in the list can be moved to the head of the current list. Similarly, if neighbouring above or left blocks are coded by single model LM or CCCM, the single model LM or CCCM candidates in the list can be moved to the head of the current list. Similarly, if GLM is used by neighbouring above or left blocks, the GLM related candidates in the list can be moved to the head of the current list.

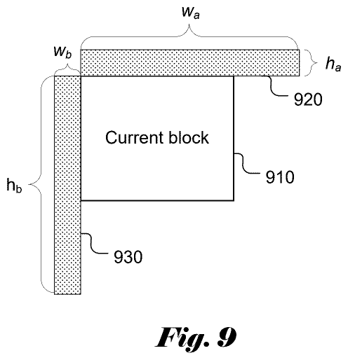

In still another embodiment, the reordering rule is based on the model error by applying the candidate model to the neighbouring templates of the current block, and then compare the error with the reconstructed samples of the neighbouring template. For example, as shown in FIG. 9, the size of above neighbouring template of the current block is wₐ×hₐ, and the size of left neighbouring template of the current block is w_{b}×h_{b}. Suppose K models are in the current candidate list, and αₖ and βₖ are the final scale and offset parameters after inheriting the candidate k. The model error of candidate k corresponding to the above neighbouring template is:

$${e}_{a}^{k} = {\sum }_{i , j} \vert ( {α}_{k} \times {recL}_{a}^{′ ( i , j )} + {β}_{k} ) - {recC}_{a}^{( i , j )} \vert$$

where,

$${recL}_{a}^{′ ( i , j )} and {recC}_{a}^{( i , j )}$$

are the reconstructed samples of luma (e.g., after downsampling process or after applying GLM pattern) and reconstructed samples of chroma at position (i, j) in the above template,

$$( {α}_{k} \times {recL}_{a}^{′ ( i , j )} + {β}_{k} )$$

are predicted samples of at position (i, j) in the above template of the template, current block for candidate k, and 0≤i<wₐ and 0≤j<hₐ.

Similarly, the model error of candidate k by the left neighbouring template is:

$${e}_{b}^{k} = {\sum }_{m , n} \vert ( {α}_{k} \times {recL}_{b}^{′ ( m , n )} + {β}_{k} ) - {recC}_{b}^{( m , n )} \vert$$

where

$${recL}_{b}^{′ ( m , n )} and {recC}_{b}^{( m , n )}$$

are the reconstructed samples of luma (e.g., after applying downsampling process or GLM pattern) and reconstructed samples of chroma at position (m, n) in the left template,

$$( {α}_{k} \times {recL}_{b}^{′ ( m , n )} + {β}_{k} )$$

are predicted samples of at position (m, n) in the left template of the current block for candidate k, and 0≤m<w_{b} and 0≤n<hp.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the inherited candidate list by sorting the model error list in ascending order.

In still another embodiment, if the candidate k uses CCCM prediction, the

$${e}_{a}^{k} and {e}_{b}^{k}$$

are defined as:

$${e}_{a}^{k} = {\sum }_{i , j} \vert ( c {0}_{k} \times {recL}_{a}^{′ ( i , j )} + c {1}_{k} \times {recL}_{a}^{′ ( i , j - 1 )} + c {2}_{k} \times {recL}_{a}^{′ ( i , j + 1 )} + c {3}_{k} \times {recL}_{a}^{′ ( i - 1 , j )} + c {4}_{k} \times {recL}_{a}^{′ ( i + 1 , j )} + c {5}_{k} \times P + c {6}_{k} \times B ) - {recC}_{a}^{( i , j )} \vert \\ {e}_{b}^{k} = {\sum }_{i , j} \vert ( c {0}_{k} \times {recL}_{b}^{′ ( i , j )} + c {1}_{k} \times {recL}_{b}^{′ ( i , j - 1 )} + c {2}_{k} \times {recL}_{b}^{′ ( i , j + 1 )} + c {3}_{k} \times {recL}_{b}^{′ ( i - 1 , j )} + c {4}_{k} \times {recL}_{b}^{′ ( i + 1 , j )} + c {5}_{k} \times P + c {6}_{k} \times B ) - {recC}_{b}^{( i , j )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term.

In still another embodiment, if the above neighbouring template is not available, then

$${e}^{k} = {e}_{b}^{k} .$$

Similarly, if the left neighbouring template is not available, then

$${e}^{k} = {e}_{a}^{k} .$$

If both templates are not available, the candidate index reordering method using model error is not applied.

In still another embodiment, not all positions inside the above and left neighbouring template are used in calculating model error. It can choose partial positions inside the above and left neighbouring template to calculate model error. For example, it can define a first start position and a first subsampling interval depending on the width of the current block to partially select positions inside the above neighbouring template. Similarly, it can define a second start position and a second subsampling interval depending on the height of the current block to partially select positions inside the left neighbouring template.

In one embodiment, not all positions inside the above and left neighbouring template are used in calculating model error. It can choose partial positions inside the above and left neighbouring template to calculate model error. A smaller hₐ or w_{b} than the maximum allowed value can be chosen. For example, hₐ or w_{b} can be a constant value (e.g., hₐ or w_{b} can be 1, 2, 3, 4, 5, or 6). For another example, hₐ or w_{b} can be dependent on block size. If the current block size is greater than or equal to a threshold, hₐ or w_{b} is equal to a first value. Otherwise, hₐ or w_{b} is equal to a second value. For example, the second value can be smaller than the first value.

In one embodiment, the model error is calculated by applying only partial candidate model to the neighbouring templates of the current block. For example, if a candidate model is a multi-model mode, such as MMLM or CCCM multi-model or multi-model of CCCM variants, only the first or the second model is applied on the neighbouring templates when computing the model error.

In another embodiment, the model error is calculated by applying only partial selected model parameters to the neighbouring templates of the current block. Suppose a candidate model has m parameters, k out of m parameters can be chosen from the candidate model, where 0<k<m and m>1. When computing the model error, the unchosen parameters are set to 0 while the chosen parameters are kept the same. In another embodiment, when the model error is calculated only based on partial selected model parameters, an offset is added to the calculated model error to be the final model error. The calculated model error is the difference between the reconstruction samples of the neighbouring template and the prediction computed based on partial model parameters. If the calculated model error is denoted by e, the final model error, which is used in reordering, is e+Δe. For example, the offset A e can be a fixed offset, or the mean of neighbouring templates.

In another embodiment, the model error is calculated by applying precision-reduced model parameters to the neighbouring templates of the current block. The bit-depth of the parameters can be reduced before applying the model parameters on the neighbouring templates to compute the model error. For example, a clipping operation can be used to reduce the bit depth of the integer part or the fractional part of model parameters. An upper-bound threshold and a lower-bound threshold can be pre-determined. The thresholds can be different for different parameters. The thresholds can be different for the integer part or the fractional part. If the integer part or the fractional part of the model parameters is greater than the upper-bound threshold, the integer part or the fractional part of the model parameters is clipped to the upper-bound threshold. If the integer part or the fractional part of the model parameters is smaller than the lower-bound threshold, the integer part or the fractional part of the model parameters is clipped to the lower-bound threshold. For another example, a rounding operation can be used to reduce the bit depth of the integer part or the fractional part of model parameters. The rounding method used can be but not limited to the following methods: rounding toward negative infinity, rounding toward positive infinity, rounding toward zero, or rounding to the nearest integer (e.g., rounding away from zero, rounding half up, rounding half down, . . . ). For another example, a pruning operation can be used to reduce the bit depth. If a model parameter is smaller than a pruning threshold, this parameter will be set to zero.

In still another embodiment, the candidates of different types are reordered separately before the candidates are added into the final candidate list. For each type of the candidates, the candidates are added into a primary candidate list of a pre-defined size N₁. The candidates in the primary list are reordered. The candidates with the smallest N₂. costs are then added into the final candidate list, where N₂≤N₁. In another embodiment, the candidates are categorized into different types based on the source of the candidates, including but not limited to the spatial neighbouring models, temporal neighbouring models, non-adjacent spatial neighbouring models, and the historical candidates. In another embodiment, the candidates are categorized into different types based on the cross-component model mode. For example, the types can be CCLM, MMLM, CCCM, and CCCM multi-model. For another example, the types can be GLM-non active or GLM active.

In still another embodiment, after the candidates are reordered based on the template cost (i.e., the model error), the redundancy of the candidate can be further checked. A candidate is redundant if the template cost difference between it and its predecessor in the list is less than or equal to a threshold. If a candidate is redundant, it can be removed from the list, or it can be move to the end of the list.

### II.10 Signalling the Inherited Candidate Index in the List

An on/off flag is signalled to indicate whether the current block inherits the cross-component model parameters from neighbouring blocks or not. The flag can be signalled per CU/CB, per PU, per TU/TB, or per colour component, or per chroma colour component. A high level syntax can be signalled in SPS, PPS, PH or SH to indicate if the proposed method is allowed for the current sequence, picture, or slice.

The maximum allowed candidate number can be signalled to indicate the maximum size of the merge candidate list. The number can be signalled per CU/CB, per PU, per TU/TB, or per colour component, or per chroma colour component. A high level syntax can be signalled in SPS, PPS, PH or SH to indicate if the proposed method is allowed for the current sequence, picture, or slice. The maximum allowed candidate number of the proposed method can be shared with the maximum allowed candidate number for inter merge mode.

If the current block inherits the cross-component model parameters from neighbouring blocks, the inherited candidate index is signalled. The index can be signalled (e.g., signalled using truncate unary code, Exp-Golomb code, or fix length code) and shared among both the current Cb and Cr blocks. For another example, the index can be signalled per colour component. For example, one inherited index is signalled for Cb component, and another inherited index is signalled for Cr component. For another example, it can use chroma intra prediction syntax (e.g., IntraPredModeC[xCb][yCb]) to store the inherited index.

If the current block inherits the cross-component model parameters from neighbouring blocks, the current chroma intra prediction mode (e.g., IntraPredModeC[xCb][yCb] as defined in VVC standard) is temporarily set to a cross-component mode (e.g., CCLM_LA) at the bitstream syntax parsing stage. Later, at the prediction stage or reconstruction stage, the candidate list is derived, and the inherited candidate model is then determined by the inherited candidate index. After obtaining the inherited model, the coding information of the current block is then updated according to the inherit candidate model. The coding information of the current block includes but not limited to the prediction mode (e.g., CCLM_LA or MMLM_LA), related sub-mode flags (e.g., CCCM mode flag), prediction pattern (e.g., GLM pattern index), and the current model parameters. Then, the prediction of the current block is generated according to the updated coding information.

### II.11 Inheriting Multiple Cross-Component Models

The final prediction of the current block can be the combination of predictions of multiple cross-component models, or fusion of the predictions of the selected cross-component models with the prediction by non-cross-component coding tools (e.g., intra angular prediction modes, intra planar/DC modes, or inter prediction modes).

In one embodiment, if the current candidate list size is N, it can select k candidates from the total N candidates (where k≤N). Then, k predictions are respectively generated by applying the cross-component model of the selected k candidates using the corresponding luma reconstruction samples. The final prediction of the current block is the combination results of these k predictions. For example, if two candidate predictions (denoted as p_{cand1} and p_{cand2}) are combined, the final prediction at (x, y) position of the current block is p_{final}(x, y)=(1−α)×p_{cand1}(x, y)+α×p_{cand2}(x, y), where α is a weighting factor. Besides, the weighting factor α can be predefined or implicitly derived according to neighbouring template cost (i.e., model error). For example, by using the template cost defined in the section entitled “Reordering the candidates in the list”, the corresponding template cost of two candidates are e^{cand1} and e^{cand2}, then a is e^{cand1}/(e^{cand1}+e^{cand2}). In another embodiment, if two candidate models are combined, the selected models are from the first two candidates in the list. In still another embodiment, if i candidate models are combined, the selected models are from the first i candidates in the list.

In another embodiment, if the current candidate list size is N, it can select k candidates from the total N candidates (where k≤N). The k cross-component models can be combined into one final cross-component model by weighted-averaging the corresponding model parameters. For example, if a cross-component model has M parameters, the j-th parameter of the final cross-component model is the weighted-averaging of the j-th parameter of the k selected candidates where j is 1 . . . . M. Then, the final prediction is generated by applying the final cross-component model to the corresponding luma reconstruction samples. For example, if two candidate models are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived by neighbouring template cost, and

$${c}_{x}^{y}$$

is the x-th model parameter of the y-th candidate. For example, by using the template cost defined in the section entitled “Reordering the candidates in the list”, the corresponding template cost of two candidates are e^{cand1} and e^{cand2} is e^{cand1}/(e^{cand1}+e^{cand2}).

### Multiple Hypothesis Blending for Cross-Component Model Merge Method

Let P be an existing prediction of the current block, an additional hypothesis H is blended with the existing prediction P based on a pre-defined weighting to form the final prediction of the current block. The prediction P can be generated based on any intra/inter coding tools. The additional hypothesis is the prediction of the current block generated based on a CC merge mode. CC merge mode means that the cross-component model is inherited from a spatial, historical, or temporal neighbouring block/position. A flag is signalled to indicate whether to add the additional hypothesis to be blended with the existing prediction. If the flag indicates that the additional hypothesis is to be added, syntax related to how to generate the additional hypothesis H and/or the weighting is signalled at the encoder or parsed at the decoder.

$${P}_{final} = ( 1 - α ) P + α H$$

In one embodiment, more than one additional hypothesis can be added. Assuming N hypotheses H₁, H₂, . . . H_{N} are added to the existing prediction P₀. Then the final prediction p_{final} can be computed as following, where α₁, α₂, . . . , α_{N} are some pre-defined weightings.

$$\begin{matrix}{P}_{0} = {H}_{0} \\ {P}_{1} = ( 1 - {α}_{1} ) {P}_{0} + {α}_{1} {H}_{1} \\ ⋮ \\ {P}_{final} = {P}_{N} = ( 1 - {α}_{N} ) {P}_{N - 1} + {α}_{N} {H}_{N}\end{matrix}$$

After the syntax related to adding one additional hypothesis (including the flag and the syntax related to how to generate the additional hypothesis) is signalled, another flag can be signalled to indicate whether to add one more additional hypothesis. If the flag indicates to add one more hypothesis, syntax related to how to generate said one more hypothesis H and/or the weighting is signalled at the encoder or parsed at the decoder.

The flag and the syntax related to each additional hypothesis (including the flag and the syntax related to how to generate the additional hypothesis) are signalled/parsed recursively. Whether to signal and/or parse one flag and related syntax is dependent on whether the previous flags are signalled/parsed. If the N-th flag indicates to add the N-th additional hypothesis (i.e., H_{N}), syntax related to how to generate the N-th hypothesis and/or the weighting is signalled. And a (N+1)-th flag will be signalled to indicate whether to add a (N+1)-th additional hypothesis (i.e., H_{N+1}). If the N-th flag indicates not to add the N-th additional hypothesis, the recursion stops and the final prediction p_{final} is the combination of H₀ and N additional hypotheses.

In one embodiment, the mode is selected from the cross-component merge candidate list to generate the additional hypothesis. The inherited candidate index of the mode selected can be explicitly or implicitly indicated. For example, the candidate index can be explicitly signalled by the method in Section entitled “Signalling the inherit candidate index in the list”. The candidates in the list can be reordered by the method mentioned in Section entitled “Reordering the candidates in the list”. For another example, only the first k candidates (k>=2) in the list can be selected, and the candidate index can be explicitly signalled by the method in Section entitled “Signalling the inherit candidate index in the list”. The candidates in the list can be reordered by the method mentioned in Section entitled “Reordering the candidates in the list”. For another example, after excluding the candidates already selected by the previous added hypotheses from the list, the first candidate in the list can be implicitly selected. The candidates in the list can be reordered according to the method mentioned in Section entitled “Reordering the candidates in the list”.

In one embodiment, the final prediction of the current block can be the blend of two hypotheses. Both hypotheses, H₁ and H₂, are both generated based on CC merge mode. A flag is signalled at block-level to indicate whether to apply the blending mode.

In one embodiment, the two modes which generate H₁ and H₂ are both selected from the cross-component merge candidate list. The inherited candidate indexes of the modes selected can be explicitly or implicitly indicated. For example, the candidates in the list can be reordered according to the method mentioned in Section entitled “Reordering the candidates in the list”. The candidate index can be explicitly signalled according to the method in Section entitled “Signalling the inherit candidate index in the list”. For another example, only the first k candidates (k>=3) in the list can be selected, and the candidate index can be explicitly signalled according to the methods in Section entitled “Signalling the inherit candidate index in the list”. For another examples, the first 2 candidates are implicitly selected. For another example, an index is explicitly signalled to indicate the candidate index of the first mode, and the candidate index of the second mode is the signalled index+k, where k can be 1, 2, 3, 4, or 5.

Any of the foregoing proposed methods of simplified template cost computation for reordering cross-component prediction (CCP) candidates or selecting a target CCP candidate can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as circuits coupled to the inter/intra/prediction module of the encoder and/or the inter/intra/prediction module of the decoder, so as to provide the information needed by the inter/intra/prediction module.

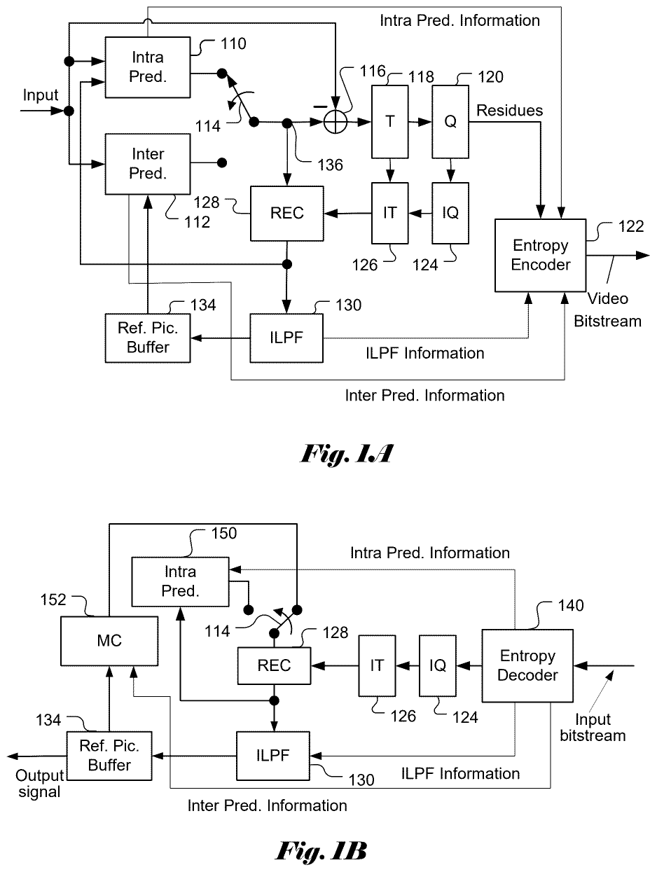

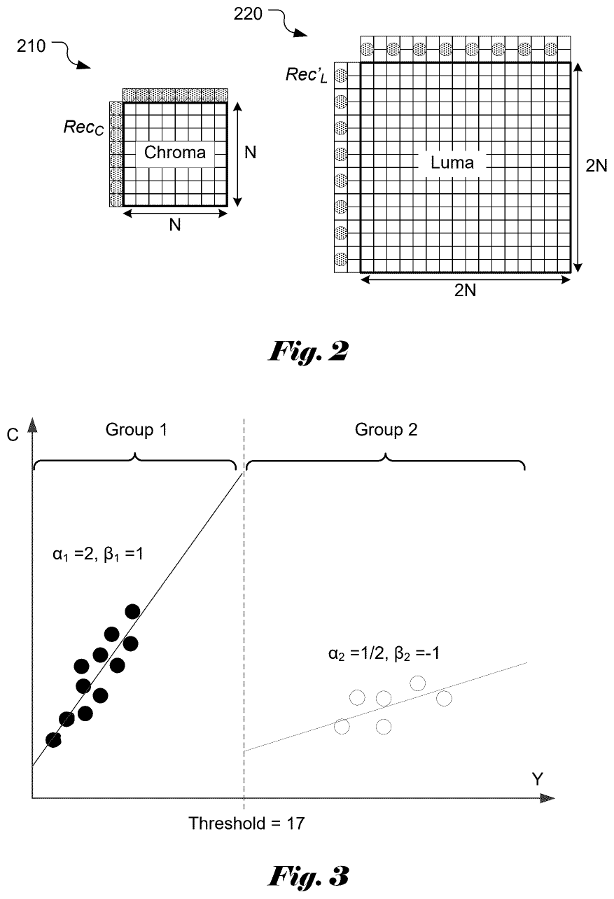

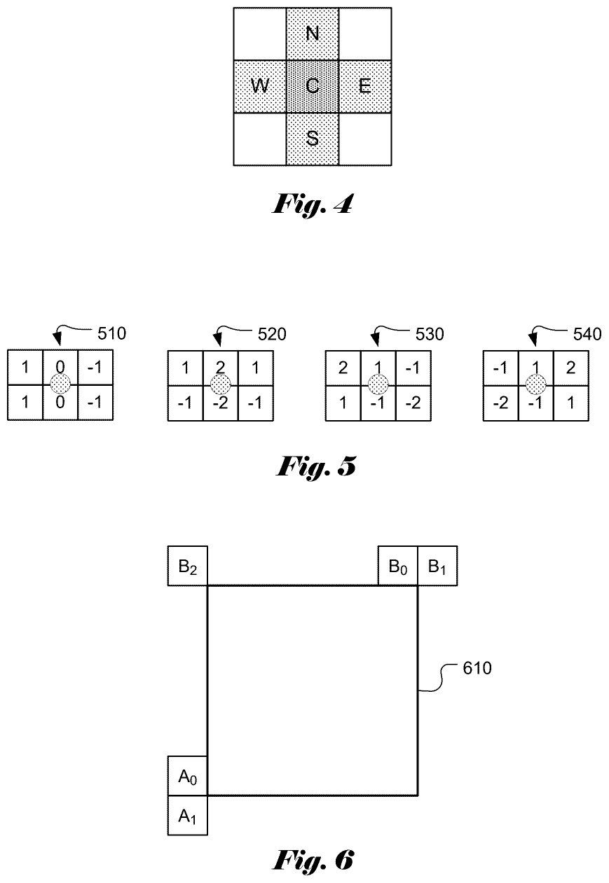

The method of using simplified template cost computation for reordering cross-component prediction (CCP) candidates or selecting a target CCP candidate can be implemented in an encoder side or a decoder side. For example, any of the proposed c method can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed candidate derivation method can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

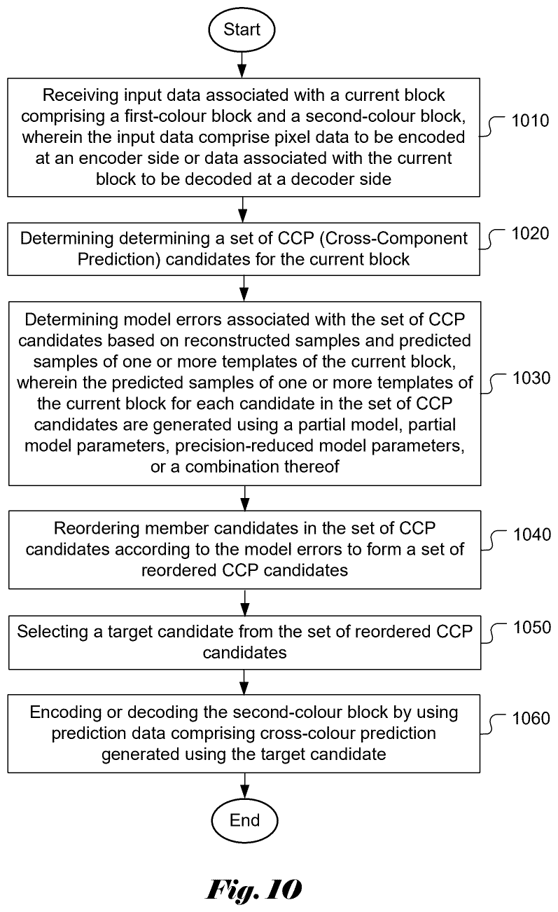

FIG. 10 illustrates a flowchart of an exemplary video coding system that uses simplified template cost computation for CCP merge mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block is received in step 1010, wherein the input data comprise pixel data to be encoded at an encoder side or data associated with the current block to be decoded at a decoder side. A set of CCP (Cross-Component Prediction) candidates for the current block is determined in step 1020. Model errors associated with the set of CCP candidates are determined based on reconstructed samples and predicted samples of one or more templates of the current block in step 1030, wherein the predicted samples of one or more templates of the current block for each candidate in the set of CCP candidates are generated using a partial model, partial model parameters, precision-reduced model parameters, or a combination thereof in step 1040. Member candidates in the set of CCP candidates are reordered according to the model errors to form a set of reordered CCP candidates in step 1050. A target candidate is selected from the set of reordered CCP candidates. The second-colour block is encoded or decoded by using prediction data comprising cross-colour prediction generated using the target candidate in step 1060.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
determining a set of CCP (Cross-Component Prediction) candidates for the current block;
determining model errors associated with the set of CCP candidates based on reconstructed samples and predicted samples of one or more templates of the current block, wherein the predicted samples of one or more templates of the current block for each candidate in the set of CCP candidates are generated using a partial model, partial model parameters, precision-reduced model parameters, or a combination thereof;
reordering member candidates in the set of CCP candidates according to the model errors to form a set of reordered CCP candidates;
selecting a target candidate from the set of reordered CCP candidates; and
encoding or decoding the second-colour block by using prediction data comprising cross-colour prediction generated using the target candidate.

2. The method of claim 1, wherein the set of CCP candidates comprise a multi-mode candidate and only a single-mode of the multi-mode candidate is used to generate the predicted samples of one or more templates of the current block.

3. The method of claim 2, wherein the multi-mode candidate corresponds to MMLM (Multiple Model CCLM (Cross-Component Linear Model)) or CCCM (Convolutional Cross-Component Mode) multi-model.

4. The method of claim 1, wherein one member candidate in the set of CCP candidates comprises m model parameters and only k model parameters are used to generate the predicted samples of one or more templates of the current block, wherein m and k are positive integers and m>k.

5. The method of claim 4, wherein one or more remaining model parameters not selected to generate the predicted samples of one or more templates of the current block are set to 0.

6. The method of claim 4, wherein a corresponding model error for the member candidate is modified by adding an offset to form a final model error.

7. The method of claim 6, wherein the offset corresponds to a fixed value or a mean of said one or more templates.

8. The method of claim 1, wherein bit-depth reduced model parameters of one member candidate in the set of CCP candidates are used to generate the predicted samples of one or more templates of the current block.

9. The method of claim 8, wherein clipping operation is used to generate the bit-depth reduced model parameters of the member candidate in the set of CCP candidates.

10. The method of claim 8, wherein pruning operation is used to generate the bit-depth reduced model parameters of the member candidate in the set of CCP candidates.

11. The method of claim 10, wherein if one model parameter is smaller than a pruning threshold, said one model parameter is set to zero.

12. The method of claim 8, wherein rounding operation is used to generate the bit-depth reduced model parameters of the member candidate in the set of CCP candidates.

13. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
determine a set of CCP (Cross-Component Prediction) candidates for the current block;
determine model errors associated with the set of CCP candidates based on reconstructed samples and predicted samples of one or more templates of the current block, wherein the predicted samples of one or more templates of the current block for each candidate in the set of CCP candidates are generated using a partial model, partial model parameters, precision-reduced model parameters, or a combination thereof;
reorder member candidates in the set of CCP candidates according to the model errors to form a set of reordered CCP candidates;
select a target candidate from the set of reordered CCP candidates; and
encode or decode the second-colour block by using prediction data comprising cross-colour prediction generated using the target candidate.
